(19) United States
(12) Patent Application Publication
(10) Pub. No.: US 2020/0229391 A1
(43) Pub. Date: Jul. 23, 2020

(54) DAIRY ANIMAL-MONITORING SYSTEM COMPRISING HEAT STRESS-REDUCING MEANS

(71) Applicant: LELY PATENT N.V., Maassluis (NL)

(72) Inventor: Ester DE GROOT, Maassluis (NL)

(73) Assignee: LELY PATENT N.V., Maassluis (NL)

(21) Appl. No.: 16/632,214

(22) PCT Filed: Jul. 10, 2018
(86) PCT No.: PCT/NL2018/050459

§ 371 Date: Jan. 17, 2020

(30) Foreign Application Priority Data
Jul. 31, 2017 (NL) 2019375
Dec. 11, 2017 (NL) 2020051

(51) Int. Cl. A01K 1/00; A01K 29/00; A01K 11/00; A01K 7/02; A01K 5/02

(52) U.S. Cl. CPC A01K 1/0082; A01K 29/005; A01K 5/02; A01K 7/02; A01K 11/006

(57) ABSTRACT

A dairy animal-monitoring system for a herd of dairy animals includes a dwelling space for the herd of dairy animals, one or more controllable heat stress-reducing means for reducing or preventing heat stress in the dairy animals, and a control system for the dairy animal-monitoring system. The control system further includes a subset-determining device for determining or inputting a subset of the herd, an identification system for identifying the dairy animals from at least the subset, and a heat stress-detecting system for detecting a value of a heat stress indicator with a dairy animal of the subset. The control system is configured to control the one or more heat stress-reducing means in several of the dairy animals on the basis of the at least one detected value.

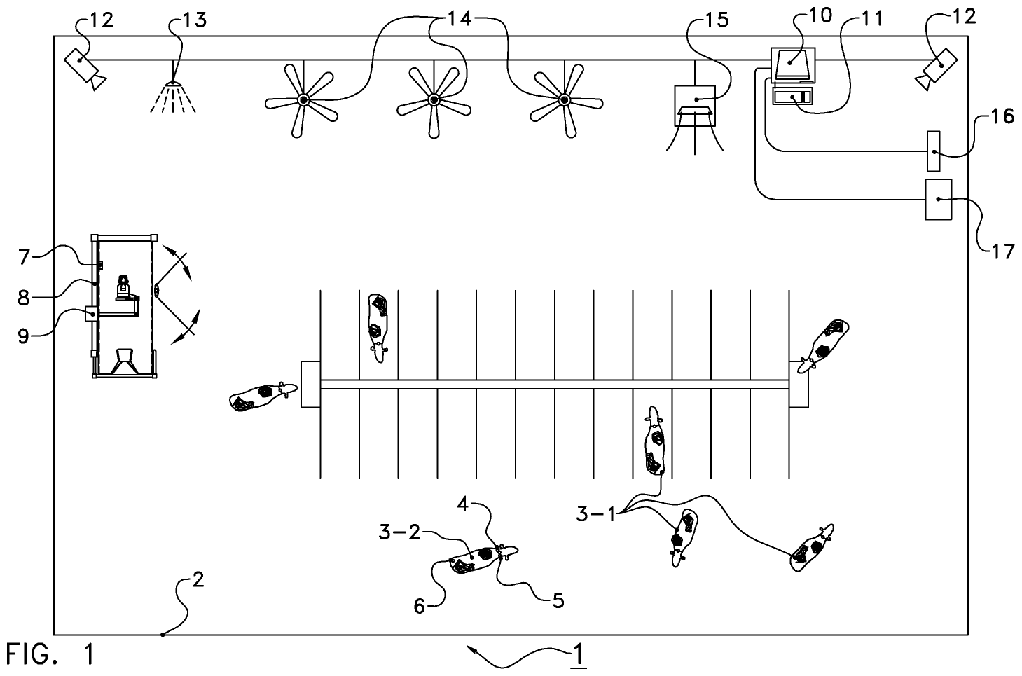

The present invention relates to a dairy animal-monitoring system comprising heat stress-reducing means.

Such systems are known from the prior art. E.g. document WO08039150A1 discloses a device which identifies individual animals, measures the temperature of the skin and/or the body of the respective animal, and subsequently switches on cooling means based on, inter alia, the measured skin or body temperature, and/or when the measured air temperature or atmospheric humidity exceeds a threshold value. Cooling down dairy animals in this way prevents a reduction in the milk production, and is consequently an important means to improve not only animal welfare, but also the milk production. In very hot weather, the production may be reduced by as much as € 5 per animal per day.

A drawback of this known device is that different circumstances which may cause the animals to experience more or less actual heat stress are not sufficiently taken into account. Just as with humans, the point is how cold or hot or moist, etc. an animal perceives it to be instead of how cold or hot or moist it actually is. In addition, the device is needlessly complicated due to the necessary animal identification.

It is therefore an object of the present invention to provide a dairy animal-monitoring system of the kind mentioned in the introduction which is able, in a simple manner, to make most, if not all, animals of a herd experience less heat stress.

This object is achieved by the invention by means of a dairy animal-monitoring system according to Claim 1, in particular a dairy animal-monitoring system for a herd of dairy animals comprising a dwelling space for the herd of dairy animals, one or more controllable heat stress-reducing means which are configured to reduce or prevent heat stress with dairy animals, and a control system for controlling the dairy animal-monitoring system which comprises a subset-determining device for determining or inputting a subset of the herd, which subset is smaller than the entire herd, an identification system for identifying the dairy animals from at least the subset, a heat stress detector for detecting a value of at least one heat stress indicator with at least one dairy animal of the subset, wherein the control system is configured to control the one or more heat stress-reducing means with several of the dairy animals based on the at least one detected value.

Herein, the invention is based on the view that not every animal is equally susceptible to heat stress and that exactly those animals which are most susceptible to heat stress can be a good gauge on which to base measures which may prevent such heat stress with other animals before it occurs and thus also before it can be measured with those other dairy animals. This may be achieved by only monitoring a subset of dairy animals, which is much easier than monitoring all dairy animals in the herd. For example, there will always be occasions where an animal in the herd cannot be monitored for a short period of time because it is concealed by other animals or equipment, or because there is a failure in the dairy animal-monitoring system. In some cases, no risk is taken and unnecessary cooling actions are performed. The chances of this happening are much greater than that of an animal of a (much smaller) subset evading monitoring. Therefore, much less stringent measures, if any, have to be taken to prevent this from happening. But it is also easier to tell the small number of animals of a (small) subset apart, so that the identification system may, in principle, be simpler and the risk of incorrect identification will also be smaller. In this way, the dairy animal-monitoring system may be simpler and still more reliable.

It should be noted here that the dairy animal-monitoring system according to the invention may, in principle, also comprise other components, such as a milking device, in particular one or more milking robots. However, these components do not form the core of the invention and will therefore not be explained in any more detail here.

Specific embodiments are described in the dependent claims and in the following part of the description.

In particular, the control system is configured to control, based on the at least one detected value, the one or more heat stress-reducing means for a predetermined or previously input susceptible portion of the herd, more particularly for substantially the entire herd in the dwelling space. With this embodiment, it is thus possible to treat the entire herd, based on measured value(s) with one or more indicator animals. Heat stress can then be prevented with most animals by keeping an eye on the most susceptible animals. It may also be the case that the susceptibility for, in particular, heat stress differs between animals within the herd to such an extent, that it is better not to subject all animals to the same heat stress-reducing treatment. For example, only a portion of the herd is marked as being susceptible, in which case said portion of the herd can be treated with the heat stress-reducing means based on the value(s) measured with the subset (indicator animals) of that portion of the herd. Thus, the heat stress reduction can be applied in an even more selective way.

In embodiments, the subset comprises between 1 and 10% of the number of animals in the herd. With such a percentage of animals, it is possible to achieve a good balance between reliability of the control and effort/costs for the system. The percentage depends slightly on the size of the herd, with a larger herd making it possible to have a subset size of a smaller percentage while maintaining the statistical reliability. In addition, all this may depend on the individual characteristics of animals. If the herd contains one or more animals which are highly susceptible, it may already suffice to monitor these. Partly for this reason, the subset is in particular between 1 and 10 dairy animals of the herd. In this case, it may be sufficient to monitor one single very susceptible dairy animal, although the statistical reliability increases if the subset contains a larger number of dairy animals. In most cases, a number of up to 10 dairy animals will statistically give a sufficient degree of reliability, even with a large herd. The size of the subset may also be based on the size of the susceptible portion of the herd, if this has been determined separately. As the susceptible portion will obviously be smaller than the entire herd, the subset can also become slightly smaller. It is advantageous to maintain the same percentage limits.

In embodiments, the subset-determining device comprises an input means, such as a keyboard or a data connection. In this way, a farmer or other operator can input those dairy animals into the subset which result in a reliable monitoring system. If an animal from the subset leaves the herd (when it is dry, calves, is slaughtered or the like) the subset can or has to be adapted. In this case, it should be noted that the herd according to this invention advantageously only comprises lactating dairy animals, because with these, the disadvantageous effect of heat stress may manifest itself immediately in a reduced milk yield. Nevertheless, heat stress is also disadvantageous for other animals in the herd, so that counteracting it will eventually also result in greater welfare for these animals. Such other animals may also be dry cows, if these remain in the herd, young cattle, etc. Even if the susceptibility of one or more animals in the subset or in the rest of the herd changes, it may be sensible to change the composition and/or size of the subset. This can be done easily by means of the input means, such as a keyboard or scanner or the like. In the same way, it is possible to input or determine the susceptible portion of the herd, if desired. The subset of the susceptible portion may also be determined or updated by the farmer or operator based on current or past observations, and/or on changes in the composition of the herd. Favourable past observations are, for example, a previous bout of pneumonia or other illness relevant to heat stress, or a direct observation of poor well-being which occurs sooner than with other animals, such as a drop in the milk yield, gasping, etc. The present invention requires the provision of an animal identification system. In embodiments, the identification system comprises at least one of a tag-reading system, and a camera system with animal-recognition software. A tag-reading system comprises, for example, a tag reader and a pair of tags attached to the animals. Obviously, in this case, at least the animals of the subset have such a tag, which contains an RFID chip or another transponder. Alternatively or additionally, the animal identification system comprises a camera system with animal-recognition software. In this case, the system is configured to determine an animal identity based on one or more characteristics, such as a shape, dimension, spotting pattern, barcode or other ID characteristic of the animal which may or may not be provided thereon. Advantageously, the camera system comprises several cameras, distributed over the dwelling area of the herd, such as the animal shed, so that at least the subset of dairy animals can be monitored reliably. Advantageously, at least one camera is arranged so as to be movable under the control of the control device and the animal-recognition software furthermore comprises animal-tracking software to be able to track a recognised animal. Such software is known per se from the prior art and makes the monitoring device even more reliable.

In particular, the animal identification system is operatively provided on or at a part of the dwelling space which is reliably visited by, in principle, all animals in the herd. An example thereof is a milking device, in particular a milking robot which always comprises an animal identification system to recognise dairy animals and prepare and perform the milking operation, based on the identification. In addition, optionally automatic, feeding systems, such as a feeding feeding fence or a concentrate station, and in particular watering devices, are highly suitable for arranging an animal identification system, because this will be visited several times every day. In this way, each dairy animal, also of the subset, can be reliably monitored, at least at that moment. An animal-tracking animal recognition system may also start to track any lost animal from that spot. It is also possible for an animal recognition system to be provided on a vehicle or aircraft which moves through the dwelling space. Such a moving vehicle or aircraft offers the advantage that it has many more moments of interaction with the animals can thus collect more information about the heat stress in real time.

In embodiments, the heat stress-detecting system comprises at least one of a camera system with animal recognition software, an activity meter and a thermometer for measuring a skin, ear or core temperature of the dairy animal of the subset. In this case, it is possible that the camera system for heat stress detection and a camera system for animal recognition to form one unit, only comprising added software for, in this case, two purposes. Animal behaviour which indicates heat stress comprises, for example, panting or gasping or positioning the front legs higher than the hind legs for prolonged periods of time or often in relatively quick succession. The animal recognition software is then advantageously configured to recognise if an animal, optionally from the subset, gasps, more advantageously for a period which is longer than a predetermined period, such as 10 minutes.

In addition, dairy animals affected by the onset or advanced stages of heat stress will often be less active. Thus, the observed displacement will be less, with regard to speed and/or distance, and/or the number of movements will be less than average for that dairy animal. For example, the camera system with animal recognition software is configured to recognise and measure such displacements and/or movements. Alternatively or additionally, the dairy animals of the subset may be provided with an activity meter, such as a step counter or mastication/rumination sensor, such as for example available from Nedap or SCR. It is also possible for a thermometer to be provided which is configured to measure a skin temperature, an ear temperature or a core temperature of the dairy animal. The skin temperature may be measured, for example, by means of a thermometer which is pressed on the skin, such as at a milking device or feeding station. There, the animal identity is preferably also determined using a tag-reading device or the like. Alternatively or additionally, an ear temperature may be determined, such as by means of an earmark using a(n infrared) thermometer, for example the Cow Manager by Agis Automatisering. Furthermore alternatively or additionally, a core temperature meter may be provided, such as for example a milk thermometer, in which case the milk temperature is a good proxy for the core temperature of the animal.

Additionally or alternatively, the heat stress-detecting system comprises an animal-locating system which comprises a memory containing location-related information, comprising the position of one or more relatively cool areas and/or one or more relatively warm areas in the dwelling space, and wherein the heat stress-detecting system is configured to identify heat stress if the visiting frequency to or the animal density of at least one of the cool areas increases by more than a threshold value and/or the visiting frequency to or the animal density of at least one of the warm areas decrease by more than a threshold value. In particular, this again concerns measurements on the subset of the herd or of the susceptible portion of the herd. The threshold value may be an absolute FIGURE or a relative FIGURE and will be determinable in practice, advantageously based on the temperature and/or atmospheric humidity and/or the heat index. Knowledge of the relatively warm and/or cool areas may have been input into in the system by the farmer or another person and may, for example, depend on the time of day and/or year. The knowledge may also be gathered and evaluated automatically by the heat stress-detecting system using several thermometers, atmospheric humidity meters and the like.

Advantageously, it is possible for the control unit to switch on or operate heat stress reduction means in the one or more warm or cool areas. In the warm areas, the (excessively) great heat will be reduced in situ, so that the animals will experience these areas as being less unpleasant and the heat stress is consequently reduced there. In the cool areas, the cooling effect of these areas will increase when operating the heat stress-reducing means, so that the animals will have a better shelter there when it is hot. In addition, both effects may result in a herd which is distributed more evenly, so that the animals will, on average, not only experience less heat from one another, but, in addition, will also experience less ordinary stress due to the on average larger distance.

Furthermore, a readout system is advantageously provided for reading out one or more sensor devices provided on the dairy animals, such as the thermometer(s) and/or activity meters. In this way, the condition of the or each respective dairy animal can be monitored more often, up to and including in real time, due to the fact that the readout system passes the measured values on to the control unit correspondingly more often or even in real time. The readout system may comprise a small transmitter for each animal or a remotely readable tag. Alternatively, it is possible for a tag-reading device to in each case read out the information on a sensor device worn by the animal, such as in a collar or ear tag, in a milking robot, at a feeding or watering installation etc., and to send it to the control unit.

A significant advantage of the present invention is the fact that such sensors worn by the animal only have to be provided on the dairy animals of the subset. This may result in a large cost saving for the required equipment and may additionally save time for fitting, maintaining and reading-out of the sensors. Also, the amount of information to be processed may remain limited in this way. Alternatively, it is possible to nevertheless provide several, in particular all, other animals of the herd with one or more of said sensor devices. Thus, it remains possible to take into account irregular or alarming values with one or more animals outside the subset. In embodiments, the heat stress-detecting system is furthermore configured to determine a value of at least one heat stress indicator with at least one dairy animal of the herd outside the subset, and the subset-determining device is configured to automatically modify the subset, based on the at least one value determined with the at least one dairy animal outside the subset and on the at least one value determined with the at least one dairy animal of the subset. In this way, the system, the control unit, is modified in order to adjust the subset of dairy animals to be monitored in order to automatically process new data, if these give cause to do so, to produce modifications of this subset. In general, the control system is configured to switch on the (general) heat stress-reducing means if a parameter value of a dairy animal from the subset falls below or exceeds a limit, such as an excessively high skin or core temperature or an excessively low number of steps and/or ruminating movements per unit time. If another dairy animal does this one or more times before a dairy animal from the subset, then this other dairy animal is added, or the other dairy animal replaces another dairy animal from the subset, such as the least critical dairy animal from the subset. An algorithm for such measures can easily be provided in the control unit. It is furthermore important to note that it is also possible to determine the subset or the susceptible portion of the herd ab origine by means of such an algorithm. To this end, the control unit comprises, for example, an inclusion criterion as well as one or more of the said sensor devices. The inclusion criterion may then, for example, comprise that the milk yield drops by at least a predetermined amount or percentage, which predetermined amount or percentage may be a function of the temperature and/or atmospheric humidity. These latter variables may be measured using conventional equipment and the results may be made available to the control unit. It is also possible to determine a single parameter, such as the heat index, based on these data. To determine the milk yield, the achieved milk production is used in principle, either from a total milk yield per day or another time period or from a ratio of the yield at a milking session divided by the time since the last milking session. The inclusion criterion is met, for example, if this milk production drops by at least 10% at a temperature of 25° C. and an RV of 80%. Obviously, other inclusion criteria are also possible, partly depending on the famer's wishes.

The heat stress-reducing means are not limited specifically. It should however be noted that these means are in principle intended to reduce heat stress for more than one dairy animal. The means are expressly not intended for individual heat stress reduction, which would, after all, also entail individual heat stress measurement for every dairy animal. In embodiments, the heat stress-reducing means comprise at least one of a ventilation system, atomizers/nozzles and an air-conditioning system. Such means are readily suitable to condition the environment for several dairy animals simultaneously in such a way that the heat stress is reduced for the affected dairy animals, such as those from the subset, and does not even occur with the dairy animals which are not yet affected. Such a ventilation system advantageously comprises ventilation openings or ventilators for all or part of the animal shed which are controllable by the control unit on the basis of the detected value of the heat stress indicator. Alternatively or additionally, the means comprise an air-treatment apparatus which blows cooled and/or dried air into the dwelling space. Alternatively or additionally, the means comprise one or more nozzles or atomizers which can spread water in the dwelling space, either directly onto the dairy animals, so that these may cool down due to evaporation of the water on their skin, or in front of ventilators, so that these can additionally cool the air which is moved around using forced evaporation.

Other heat stress-reducing means are not excluded, such as controllable sun shades, in order to reduce, at least control, the solar radiation. It is also possible to add an additive to the feed or optionally to the drinking water. In particular, the heat stress-reducing means comprise a bicarbonate-adding device which adds a predetermined amount of (sodium) bicarbonate to, for example, the roughage. The addition is then advantageously performed for each animal of the susceptible portion of the herd or, if desired, to each animal of the herd.

Advantageously, the system furthermore comprises a measuring device which is operatively connected to the control unit for measuring a value of a weather parameter, such as the atmospheric humidity, an ambient temperature or the solar radiation. The control unit can thus control the heat stress-reducing means, partly on the basis of the determined parameter value. For example, it makes less sense to use atomizers or nozzles if the determined atmospheric humidity exceeds a threshold value.

The invention will now be explained in more detail by means of the drawing, in which a non-limiting embodiment is shown in the sole FIGURE.

The FIGURE shows a dairy-animal monitoring device 1 with an animal shed 2 containing dairy cows 3-1 and an indicator cow 3-2, each provided with an ID tag 4 on a collar. The indicator cow 3-2 is furthermore provided with a skin thermometer 5 and a step counter 6.

The ID tag 4 is readable by a tag reader 7 of a milking stall 8 with a milking robot 9. Reference numeral 10 denotes a control unit with a keyboard 11.

Furthermore, cameras 12, a nozzle 13, ventilators 14 and an airconditioning unit 15, as well as an air thermometer 16 and an atmospheric humidity meter 17.

In the animal shed 2 of the device 1, a herd of cows is present, for the sake of simplicity only seven animals here, but in practice often many more, up to a few hundred animals. The greatest portion of these animals are “normal” cows 3-1, without a special status. However, some animals are provided with the status indicator cow 3-2, because they are known to be susceptible to heat stress and will suffer disadvantageous consequences sooner, at least this heat stress will sooner result in visible symptoms or symptoms which are otherwise measurable. The status of the indicator cows 3-2 may be input beforehand into the control unit 10 via the keyboard 11 or in another way, such as a data connection.

Here, the ratio between the number of indicator cows 3-2 and the number of non-indicator cows 3-1 is 1:6, so that only one sixth of all cows has to be monitored. With larger herds, this ratio can often be even lower, such as 1:10 or even 1:100. All this depends on the relative susceptibility of the cows 3-1, 3-2 and the desired susceptibility/accuracy, but in practice, it is relatively easy to determine a number which results in suitable information for the farmer.

On their collar, the indicator cows 3-2 have an ID tag 4 which every cow 3-1, 3-2 wears, as well as a skin thermometer 5 and/or a step counter 6. The latter two are examples of measuring means for determining a heat stress value or at least a parameter value which is coupled thereto. In this case, the skin thermometer 5 serves to measure a skin temperature of the indicator cow 3-2 which will increase in the case of heat stress. The step counter 6 is an activity meter which measures the activity of the indicator cow 3-2 in the form of the number of steps per unit time. When heat stress occurs, the indicator cow 3-2 will slowly but surely become less active and may even become apathetic, which will show itself in a smaller number of steps per unit time. Other heat stress indicator measuring means are not excluded and are, for example, a respiration meter. Cows which suffer in the heat will start to gasp more, which will show itself in a higher breathing frequency.

The measured heat stress is an indication that the well-being of the cows concerned, in this case indicator cows 3-2, has deteriorated and that they will consequently eat less and give less milk. Since the milking only takes place two to three times a day, determining heat stress via the milk yield may often result in it being too late. It is thus important for the well-being and milk yield to detect heat stress in time in order to prevent a drop in the milk yield. The best way of achieving this is to use indicator cows 3-2 which suffer from visible or measurable consequences most quickly. In this way, a drop in the milk yield in most other cows 3-1 can be prevented before it becomes noticeable. In addition, it thus suffices to monitor a smaller number of cows, which is simpler while at the same time being more accurate, partly because only a limited number of animals require measuring means.

The heat stress could also be determined via a camera system with cameras 12 which are connected to the control unit 10, in which an image-processing program which, for example, determines the activity of indicator cows 3-2 from the images. In addition, the camera system can be used to recognise the indicator cows 3-2 in the herd. In this case, it is advantageous if only a minority of the cows of the herd are indicator cows 3-2 and the rest are ordinary cows 3-1. As a result, image processing will have to distinguish fewer cows, which makes recognition more reliable. The ID tag 4 could also comprise an optical mark, such as a barcode or specific colour or the like. Often, the ID tag comprises an RFID chip which is readable in, for example, the milking stall 8 by a tag reader 7 which is provided there. The latter is advantageous in order to be able to operate the milking robot 9 on the basis of the detected animal identity. It is also possible to read out one or all measuring device there, such as the skin thermometer 5 or the activity meter/step counter 6, and coupled to the animal identity sent to the control unit.

Based on one or more of the above-described methods, the control unit 10 collects data about possible heat stress with the indicator cows 3-2. If the control unit 10 finds that heat stress has occurred by comparing one or more of the measured values to reference or threshold value and determining that they fall below or exceed the latter, then the control unit can switch on one or more cooling means. To this end, a nozzle 13 is provided, for example, which can atomize water or spray it onto the cows 3-1 and 3-2. The water which evaporates in the air or on the skin then provides cooling, either indirectly or directly. Additionally or alternatively, ventilators 14 are provided, for example, which can move the air in the animal shed. This may also assist the evaporation. Additionally or alternatively, an air-conditioning unit 15 may be provided which may actively cool the air in the animal shed 2, but may also lower the atmospheric humidity, so that evaporation may also be assisted. On the basis of the degree of heat stress, i.e. the degree to which the measured values fall below or exceed threshold or reference values, the control unit may operate and actuate one or more of said cooling means 13, 14, 15. If several nozzles 13 have been provided, the control unit may decide, based on the position of cows suffering from heat stress, to only switch on the nozzles 13 at the location of the heat-stressed cows.

In addition, it is possible to also monitor a heat stress indicator for one or more other cows 3-1, i.e. non-indicator cows 3-1, for example by means of the cameras 12. If the control unit, preferably repeatedly, detects that one or more of the non-indicator cows 3-1 become heat-stressed before one or more indicator cows, then the control unit may determine to replace the indicator cows 3-2 which are least susceptible to heat stress cows 3-2 by the one or more non-indicator cows 3-1 which were earlier found to suffer from heat stress. The control unit 10 then changes the status/classification of these cows. In this way, the control unit can continually optimize the set of indicator cows 3-2. In this case, the system 1, in particular the control unit 10, has to be able to determine the identity of the respective non-indicator cow(s) 3-1. This may be achieved at least by emitting an alarm to the farmer, so that he can determine the respective identity and can input the respective cow(s) via the keyboard 11. If desired, this may take place in an automated manner by monitoring the respective non-indicator cow with the same cameras 12 until it passes a tag reader 7, in which the ID tag 4 is read out and the identity is discovered. As another alternative, image-recognition information may be stored for each cow, 3-1 and 3-2, so that each cow can be recognised by the control unit. Even then it is still easier for the control unit to only have to monitor some of the cows for heat stress, so that the computing capacity or the data traffic can remain correspondingly limited.

It is also possible to use other heat-stress indicator measuring means instead of one or more cameras 12, such as a milk thermometer which is a core temperature indication. Naturally, the milk temperature is measured during a milking operation and thus only occurs twice a day. Nevertheless, such additional information may also be used to adjust at least the subset “indicator cows” 3-2.

The illustrated embodiments only serve to explain the invention and not to limit it. The scope of protection is defined by means of the attached claims.

1: A dairy animal-monitoring system for a herd of dairy animals comprising:
a dwelling space for the herd of dairy animals;
one or more controllable heat stress-reducing means which are configured to reduce or prevent heat stress with dairy animals; and
a control system for controlling the dairy animal-monitoring system, the control system further comprising
a subset-determining device for determining or inputting a subset of the herd, which subset is smaller than the entire herd,
an identification system for identifying the dairy animals from at least the subset, and
a heat stress detection system for detecting a value of at least one heat stress indicator with at least one dairy animal of the subset,
wherein the control system is configured to control the one or more heat stress-reducing means with several of the dairy animals based on the at least one detected value.

2: The dairy animal-monitoring system according to claim 1, wherein the subset comprises between 1 and 10% of a number of animals in the herd.

3: The dairy animal-monitoring system according to claim 1, wherein the subset-determining device comprises an input means.

4: The dairy animal-monitoring system according to claim 1, wherein the identification system comprises at least one of a tag-reading system and a camera system with animal-recognition software.

5: The dairy animal-monitoring system according to claim 1, wherein the heat stress detector comprises at least one of a camera system with animal recognition software, an activity meter, and a thermometer for measuring a skin, ear or core temperature of the at least one dairy animal of the subset.

6: The dairy animal-monitoring system according to claim 1, wherein the heat stress-detecting system is furthermore configured to determine a value of at least one heat stress indicator with at least one dairy animal of the herd outside the subset, and wherein the subset-determining device is configured to automatically modify the subset, based on the at least one value determined with the at least one dairy animal outside the subset and on the at least one value determined with the at least one dairy animal of the subset.

7: The dairy animal-monitoring system according to claim 6, wherein the heat stress-detecting system is provided with an animal-locating system which comprises a memory containing location-related information, comprising the position of one or more relatively cool areas and/or one or more relatively warm areas in the dwelling space, and wherein the heat stress-detecting system is configured to identify heat stress if a visiting frequency to or an animal density of at least one of the cool areas increases by more than a threshold value and/or a visiting frequency to or an animal density of at least one of the warm areas decreases by more than a threshold value.

8: The dairy animal-monitoring system according to claim 1, wherein the heat stress-reducing means comprises at least one of a ventilation system, atomizers/nozzles and an air-conditioning unit.

9: The dairy animal-monitoring device according to claim 1, wherein the heat stress-reducing means comprises a bicarbonate-adding device which adds a predetermined amount of (sodium) bicarbonate to the feed or drinking water.

10: The dairy animal-monitoring device according to claim 1, wherein the control system is configured to control the one or more heat stress-reducing means with several of the dairy animals based on the at least one detected value, and with substantially the entire herd in the dwelling space.

11: The dairy animal-monitoring device according to claim 1, wherein the subset comprises between 1 and 10 dairy animals of the herd.

12: The dairy animal-monitoring device according to claim 3, wherein the input means comprises a keyboard or a data connection.
